(19) United States
(12) Patent Application Publication
(10) Pub. No.: US 2022/0093128 A1
(43) Pub. Date: Mar. 24, 2022

(54) METHOD OF PRODUCING PAINT, METHOD OF PRODUCING MAGNETIC RECORDING MEDIUM, METHOD OF MEASURING DISPERSIBILITY OF PAINT, AND STIRRING APPARATUS

(71) Applicant: SONY GROUP CORPORATION, TOKYO (JP)

(72) Inventors: HIDETOSHI NISHIYAMA, TOKYO (JP); YUUICHI MASUZAWA, TOKYO (JP); TAKUYA NAGANUMA, MIYAGI (JP)

(21) Appl. No.: 17/424,646

(22) PCT Filed: Jan. 24, 2020
(86) PCT No.: PCT/JP2020/002581

§ 371 Date: Jul. 21, 2021

(30) Foreign Application Priority Data
Jan. 31, 2019 (JP) 2019-015491

(51) Int. Cl. G11B 5/842; B01F 35/21; B01F 35/221; B01F 35/22

(52) U.S. Cl. CPC G11B 5/842; B01F 35/2133; B01F 35/2215; B01F 35/2214; B01F 35/2202; B01F 35/2216; B01F 35/2115

(57) ABSTRACT

A method of producing paint includes: measuring an impedance of paint containing a magnetic powder; and controlling stirring of the paint on the basis of the measured impedance.

### TECHNICAL FIELD

The present disclosure relates to a method of producing paint, a method of producing a magnetic recording medium, a method of measuring dispersibility of paint, and a stirring apparatus.

### BACKGROUND ART

With the increase in recording volume in recent years, a tape-shaped magnetic recording medium is increasingly required for backup applications. In the tape-shaped magnetic recording medium, in order to improve the recording density, a magnetic recording medium of a perpendicular magnetic recording system in which magnetic powders are oriented in the thickness direction of a magnetic layer has been adopted instead of a longitudinal magnetic recording system in which magnetic powders are oriented in parallel with the longitudinal direction of a magnetic layer, which has been a mainstream method in the past.

In the magnetic recording medium of the perpendicular magnetic recording system, it is important to improve the perpendicular orientation of the magnetic powder. In Patent Literature 1, as a technology for improving the perpendicular orientation of the magnetic powder, a technology in which paint for forming a magnetic layer is applied to a film-like support and then dried while adjusting the orientation of the magnetic powder by applying an external magnetic field in the thickness direction of the coating film with a permanent magnet has been adopted.

### CITATION LIST

### Patent Literature

Patent Literature 1: WO 2018/203468

### DISCLOSURE OF INVENTION

### Technical Problem

The orientation of the magnetic powder depends on the dispersion state of the magnetic powder in paint. That is, since an aggregated massive magnetic powder has a large inertial force and the motion thereof is dull even if an external magnetic field is applied thereto, it is difficult to perpendicularly orient the magnetic powder as intended. When the magnetic powder becomes finer as the recording density increases, the magnetic powder is more likely to aggregate, making it more difficult to perpendicularly orient the magnetic powder as intended.

Therefore, in order to improve the perpendicular orientation of the magnetic powder, a method of evaluating the dispersibility of the magnetic powder on the basis of the paint state is desired, but such an evaluation method does not exist in the past.

It is an object of the present disclosure to provide a method of measuring dispersibility of paint, a method of producing paint using this measurement method, a method of producing a magnetic recording medium, and a stirring apparatus that are capable of evaluating the dispersibility of the magnetic powder on the basis of the paint state.

### Solution to Problem

In order to achieve the above-mentioned object, a first disclosure is a method of producing paint, including:
measuring an impedance of paint containing a magnetic powder; and
controlling stirring of the paint on the basis of the measured impedance.

A second disclosure is a stirring apparatus, including:
a stirring unit that stirs paint containing a magnetic powder;
an impedance measuring unit that measures an impedance of the paint containing a magnetic powder; and
a control unit that controls the stirring unit on the basis of the measured impedance.

A third disclosure is a method of producing a magnetic recording medium, including:
measuring an impedance of paint containing a magnetic powder;
controlling stirring of the paint on the basis of the measured impedance; and
forming a magnetic layer using the paint whose stirring is controlled.

A fourth disclosure is a method of measuring dispersibility of paint, including:
measuring an impedance of paint containing a magnetic powder.

### BRIEF DESCRIPTION OF DRAWINGS

FIG. 1 is a schematic diagram showing an example of a configuration of a stirring apparatus according to a first embodiment of the present disclosure.

Part A of FIG. 2 is a side view showing an example of a configuration of a part of a pipe where an impedance measuring unit is provided. Part B of FIG. 2 is a cross-sectional view taken along the line IIB-IIB in Part A of FIG. 2.

FIG. 3 is a graph showing a relationship between the stirring time and the impedance.

FIG. 4 is a flowchart for describing an example of an operation of the stirring apparatus according to the first embodiment of the present disclosure.

FIG. 5 is a flowchart for describing an example of an operation of temperature control.

FIG. 6 is a flowchart for describing an example of an operation of concentration control.

FIG. 7 Part A of FIG. 7 is a schematic diagram showing an example of a configuration of a stirring unit in which an impedance measuring unit is provided. Part B of FIG. 7 is a schematic diagram for describing an example of off-line impedance measurement.

FIG. 8 is a cross-sectional view showing an example of a configuration of a tape-shaped magnetic recording medium according to a second embodiment of the present disclosure.

FIG. 9 is a graph showing a relationship between the frequency and the impedance.

FIG. 10 is a graph showing a relationship between the frequency and the phase difference (phase difference of a voltage with respect to a current).

FIG. 11 is a graph showing a relationship between the dispersion time, the impedance, and the degree of perpendicular orientation(squareness ratio in the longitudinal direction).

FIG. 12 is a graph showing a relationship between the frequency and the degree of perpendicular orientation (squareness ratio in the longitudinal direction).

### MODE(S) FOR CARRYING OUT THE INVENTION

In the present disclosure, the impedance measurement of paint may be one of in-line measurement and off-line measurement, but in-line measurement is favorable. In the in-line measurement, the measurement is performed in a sealed state, the change in concentration due to volatilization is small, and the positional relationship between an electrode and the wall surface of a pipe or a stirring unit of a stirring apparatus is constant, so that the factor of variation in the measurement values can be reduced as compared with the off-line measurement. In addition, in the in-line measurement, there is no need to prepare sampling paint and a container housing sampled paint unlike the off-line measurement. Further, in the in-line measurement, a measurer does not need to directly handle paint that contains an organic solvent.

Examples of a method of measuring the impedance in-line include a method of measuring the impedance of paint flowing through a pipe and a method of measuring the impedance of paint housed in a stirring unit. In this case, the measurement of impedance is performed by, for example, disposing a pair of electrodes in the pipe or in the stirring unit. From the viewpoint of suppressing generation of a stray current, it is favorable that the portion of the pipe, the stirring unit, or the like where the electrode is disposed is formed of an insulating material.

The impedance of paint is influenced by the concentration of paint, the temperature, and the flow rate in addition to the dispersion state of the magnetic powder. Therefore, it is favorable to control at least one of the factors to be constant in a measurement environment, in a stirring apparatus, or the like, which is affected by at least one factor of the concentration of paint, the temperature, and the flow rate.

Embodiments of the present disclosure will be described in the following order.
1 Overview
2 First embodiment
2.1 Configuration of stirring apparatus
2.2 Method of producing paint
2.3 Method of controlling temperature of paint
2.4 Method of controlling concentration of paint
2.5 Effects
2.6 Modified example
3 Second embodiment
3.1 Configuration of magnetic recording medium
3.2 Method of producing magnetic recording medium
3.3 Measurement value of paint
3.4 Effects
3.5 Modified example

<1 Overview>

When the present inventors have focused on the compositions of paint and carried out intensive studies, they have found the following characteristics. That is, they have found that in the paint in which conductive particles such as a magnetic powder and a dispersant are mixed in a solvent having a high insulating property, when the dispersion progresses, the chains of the particles that had a role of a conductive path are separated, the solvent having an insulating property enters between the particles, and the conductive path is divided, whereby the impedance value of the paint increases.

On the basis of the result of the above-mentioned studies, the present inventors have come to a method of measuring dispersibility of paint, a method of producing paint using this measurement method, a method of producing a magnetic recording medium, and a stirring apparatus that are capable of evaluating the dispersibility of the magnetic powder on the basis of the paint state by measuring the impedance of paint containing the magnetic powder.

<2 First Embodiment>

[2.1 Configuration of Stirring Apparatus]

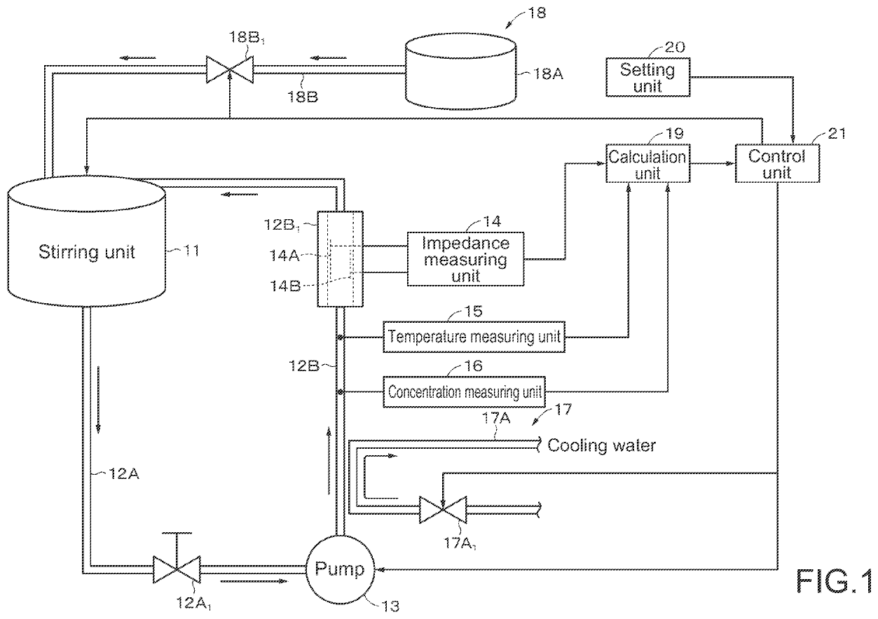

FIG. 1 shows an example of a configuration of a stirring apparatus according to a first embodiment of the present disclosure. The stirring apparatus includes a stirring unit 11, pipes 12A and 12B, a pump 13, an impedance measuring unit 14, a temperature measuring unit 15, a concentration measuring unit 16, a cooling unit 17, a solvent supplying unit 18, a calculation unit 19, a setting unit 20, and a control unit 21. The stirring apparatus may further include an output unit (not shown) such as a display device and a speaker.

(Stirring Unit)

The stirring unit 11 houses and stirs paint. The paint is, for example, paint for forming a magnetic layer of a magnetic recording medium, and includes a magnetic powder, a binder, and a solvent (organic solvent). The paint may further include, as necessary, at least one additive of a lubricant, an antistatic agent, an abrasive, a curing agent, a rust inhibitor, a non-magnetic reinforcing particle, and the like.

(Pipe)

The pipes 12A and 12B are for circulating the paint in the stirring unit 11. The pipe 12A connects the stirring unit 11 and the pump 13 to each other, and the pipe 12B connects the pump 13 and the stirring unit 11 to each other. The paint is supplied from the stirring unit 11 to the pump 13 via the pipe 12A, and the paint is returned from the pump 13 to the stirring unit 11 via the pipe 12B.

The pipe 12A is provided with a valve 12A₁. By opening and closing this valve 12A₁, the flow path between the stirring unit 11 and the pump 13 is opened and closed.

Although an example in which the valve 12A₁ is a manual operation valve is shown in FIG. 1, the valve 12A₁ may be an automatic operation value such as a solenoid valve whose opening and closing are controlled by the control unit 21. Note that the valve 12A₁ may be one capable of not only opening and closing but also adjusting the flow rate of paint.

(Pump)

The pump 13 circulates the paint in the stirring unit 11 via the pipes 12A and 12B. Specifically, the pump 13 draws the paint from the stirring unit 11 via the pipe 12A and delivers the paint to the stirring unit 11 via the pipe 12B.

(Impedance Measuring Unit)

The impedance measuring unit 14 measures the impedance of paint flowing through the pipe 12B and provides the measurement result to the calculation unit 19. As the impedance measuring unit 14, for example, an impedance analyzer or an LCR meter can be used. Since the paint itself contains a flammable organic solvent, it is desirable to measure the impedance under the condition of as low output as possible. In order to suppress an unexpected overcurrent and an unexpected overvoltage, it is desirable to consider also the use of an explosion-proof barrier of the Zener diode type, and it is desirable to determine the meter output, the cable length, and the like from the rated capacity of the explosion-proof barrier.

Part A of FIG. 2 and Part B of FIG. 2 each show an example of a configuration of a part 12B₁ of the pipe 12B where the impedance measuring unit 14 is provided. The impedance measuring unit 14 includes a pair of electrodes 14A and 14B facing each other, which are spaced apart by a predetermined distance, and measures the impedance by applying an AC voltage to paint by the pair of electrodes 14A and 14B. The electrodes 14A and 14B are, for example, parallel-plate counter electrodes each formed of a metal plate. Note that the electrodes 14A and 14B do not necessarily need to have the parallel-plate configuration, and may have a cylindrical or helical configuration. However, considering that the electrodes 14A and 14B are cleaned when the type of paint to be stirred by the stirring apparatus is changed, parallel-plate ones that can be easily cleaned are favorable as the electrodes 14A and 14B.

It is favorable that the impedance measuring unit 14 is configured to be capable of applying an AC voltage having a frequency of 10 Hz or more and 1000 Hz or less to paint by the electrodes 14A and 14B. As characteristics of the target paint, when the frequency of the AC voltage is 10 Hz or more and 1000 Hz or less, the impedance value is substantially constant with respect to the frequency and the difference for each dispersion time is large. Therefore, it is possible to measure the change in impedance due to the dispersion state with high resolution.

It is favorable that the part 12B₁ of the pipe 12B where the pair of electrodes 14A and 14B are provided is formed of an insulating material (e.g., a low-dielectric material). This is because it is possible to suppress the generation of a stray current and improve the measurement accuracy of the impedance (i.e., the measurement accuracy of the dispersion state).

Further, it is favorable that the pipe diameter or the cross-sectional area of the pipe of the part 12B₁ of the pipe 12B where the impedance measuring unit 14 is provided is made larger than the pipe diameter of the cross-sectional area of the pipe of another part. This is because it is possible to reduce the effect of the flow rate of paint on the impedance measurement and improve the measurement accuracy of the impedance (i.e., the measurement accuracy of the dispersion state).

In order to improve safety, it is favorable to further provide an explosion-proof barrier of the Zener diode type between the main body of the impedance measuring unit 14 and the pair of electrodes 14A and 14B. In this case, the impedance between the pair of electrodes 14A and 14B is measured by the impedance measuring unit 14 when a voltage value lower than the rated voltage of the explosion-proof barrier is applied. More specifically, the area of the pair of electrodes 14A and 14B and the distance between the electrode are specified so that a current that is equal to or less than the rated current of the explosion-proof barrier is obtained when a voltage value below the rated voltage of the explosion-proof barrier is applied.

(Temperature Measuring Unit)

The temperature measuring unit 15 measures the temperature of paint flowing through the pipe 12B and provides the measurement result to the calculation unit 19.

(Concentration Measuring Unit)

The concentration measuring unit 16 measures the concentration of paint flowing through the pipe 12B and provides the measurement result to the calculation unit 19.

(Cooling Unit)

The cooling unit 17 is configured to be capable of cooling paint flowing through the pipe 12B. Specifically, the cooling unit 17 includes a pipe (cooling pipe) 17A configured to be capable of circulating cooling water. A part of the pipe 17A is disposed to be juxtaposed to the pipe 12B, and paint flowing through the pipe 12B is cooled by the cooling water circulating through the pipe 17A. The pipe 17A is provided with a valve 17A₁, and the circulation of the cooling water is controlled by controlling opening and closing of this valve 17A₁. The valve 17A₁ is an automatic operation value such as a solenoid valve whose opening and closing are controlled by the control unit 21. Note that the valve 17A₁ may be one capable of not only opening and closing but also adjusting the flow rate of cooling water.

(Solvent Supplying Unit)

The solvent supplying unit 18 includes a tank 18A and a pipe 18B. The tank 18A is a housing unit for housing a solvent. The pipe 18B connects the stirring unit 11 and the tank 18A to each other. The pipe 18B is provided with a valve 18B₁. By controlling opening and closing of this valve 18B₁, the supply of a solvent from the tank 18A to the stirring unit 11 is controlled. The valve 18B₁ is an automatic operation value such as a solenoid valve whose opening and closing are controlled by the control unit 21. Note that the valve 18B₁ may be one capable of not only opening and closing but also adjusting the flow rate of cooling water by the control unit 21.

(Calculation Unit)

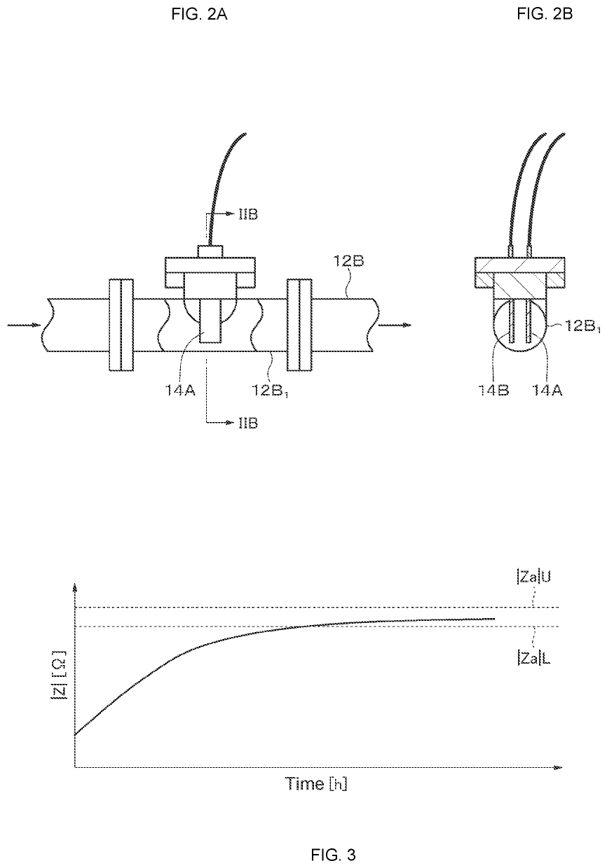

The calculation unit 19 determines, on the basis of the impedance supplied from the impedance measuring unit 14, whether or not the impedance is withing a specified range, and provides the determination result to the control unit 21. Specifically, the calculation unit 19 determines whether or not an impedance |Z| provided from the impedance measuring unit 14 is within a prescribed range (specifically, |Zₐ|L>|Z|<|Zₐ|U, where Zₐ represents a prescribed impedance and L and U are prescribed constants.) as shown in FIG. 3, and provides the determination result to the control unit 21.

Note that although a case where the calculation unit 19 determines whether or not the impedance |Z| provided from the impedance measuring unit 14 is within the prescribed range will be described in the first embodiment, the calculation unit 19 may determine whether or not the impedance |Z| provided from the impedance measuring unit 14 exceeds the prescribed impedance |Zₐ|L.

The calculation unit 19 determines whether or not there is a change in the concentration of paint on the basis of the temperature of pain supplied from the temperature measuring unit 15, and provides the determination result to the control unit 21. The calculation unit 19 determines whether or not there is a change in the concentration of paint on the basis of the concentration of paint provided from the concentration measuring unit 16, and supplies the determination result to the control unit 21. Although a case where the calculation unit 19 is provided separately from the control unit 21 will be described in the first embodiment, the calculation unit 19 may be provided in the control unit 21.

(Setting Unit)

The setting unit 20 includes an operation panel or the like for operating a stirring apparatus, and an operator can set the dispersion state or the like of paint to a desired state by operating the operation panel.

(Control Unit)

The control unit 21 controls the respective units of the stirring apparatus such as the stirring unit 11, the pump 13, the valve 17A₁, and the valve 18B₁. The control unit 21 controls, on the basis of the determination result provided from the impedance measuring unit 14, stirring of the stirring unit 11 so that the impedance is withing a prescribed range (|Zₐ|L>|Z|<|Zₐ|U). Here, the control of stirring is, for example, control of at least one of a stirring speed or a stirring period.

Specifically, the control unit 21 determines, in the case where the impedance is within the specified range, that the dispersibility of the magnetic powder is within the specified range, and controls the stirring unit 11 to stop stirring of paint. The control unit 21 determines, in the case where the impedance is less than the specified range, that the dispersibility of the magnetic powder is insufficient, and controls the stirring unit 11 to extend the stirring period in order to improve the dispersibility of the magnetic powder. The control unit 21 determines, in the case where the impedance exceeds the specified range, that some abnormality has occurred in paint, and may warn the operator that abnormality has occurred in paint via an output unit (not shown) such as a display device and a speaker.

The control unit 21 controls, on the basis of the determination result provided from the temperature measuring unit 15, opening and closing of the valve 17A₁ of the cooling unit 17 so that the temperature of paint is constant. Note that the control unit 21 may not only control the opening and closing of the valve 17A₁ but also control adjustment of the flow rate in the valve 17A₁ of the pipe 17A. The control unit 21 controls, on the basis of the determination result provided from the concentration measuring unit 16, opening and closing of the valve 18B₁ of the solvent supplying unit 18 so that the concentration of paint is constant. Note that the control unit 21 may not only control the opening and closing of the valve 18B₁ but also control adjustment of the flow rate in the valve 18B₁. The control unit 21 controls the pump 13 so that the flow rate of paint flowing through the pipes 12A and 12B is constant. An increase in the flow rate during the measurement leads to progression of the dispersion state and shifts the measurement value in the direction in which the dispersion progresses. Therefore, in the in-line measurement, it is favorable to control the flow rate of paint flowing through the pipes 12A and 12B so that the specified flow rate condition is achieved.

[2.2 Method of Producing Paint]

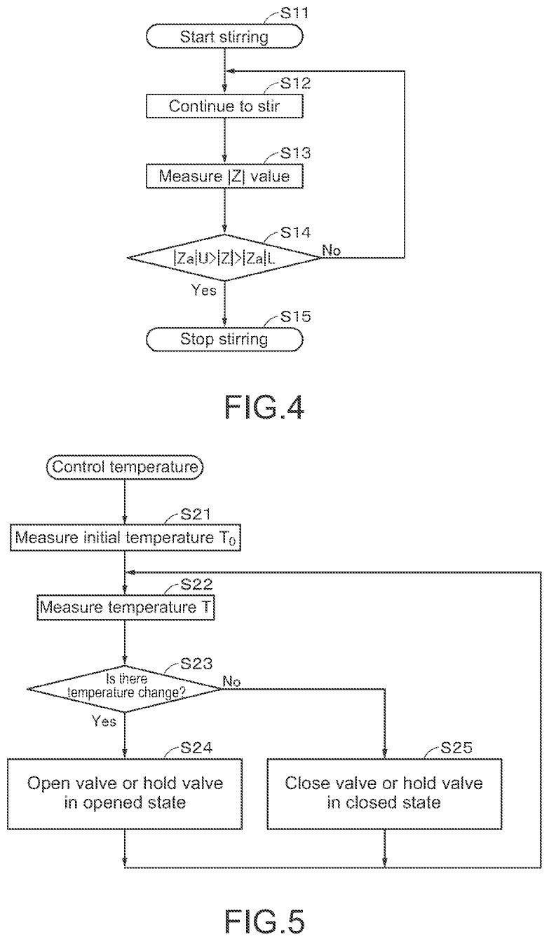

Hereinafter, an example of a method of producing paint using the above-mentioned stirring apparatus will be described with reference to FIG. 4.

First, in Step S11, in accordance with the operation of the setting unit 20 by an operator, the control unit 21 drives the stirring unit 11 to start stirring paint. Further, in accordance with the driving of the stirring unit 11, the control unit 21 drives the pump 13 to circulate the paint in the pipes 12A and 12B.

Next, in Step S12, the control unit 21 continues to drive the stirring unit 11 and drive the pump 13. Next, in Step S13, the control unit 21 measures the impedance of paint flowing through the pipe 12B by the impedance measuring unit 14. The measurement result is provided from the impedance measuring unit 14 to the calculation unit 19. By measuring the impedance of paint flowing through the pipe 12B in this way, it is possible to evaluate the dispersibility of paint.

Next, in Step S14, the calculation unit 19 determines whether or not the impedance provided from the impedance measuring unit 14 is within a specified range (|Zₐ|U>|Z|>|Zₐ|L), and provides the determination result to the control unit 21. In the case where the control unit 21 receives, from the calculation unit 19, the determination result indicating that the impedance is within the specified range, the control unit 21 stops driving of the stirring unit 11 and the pump 13. Meanwhile, in the case where the control unit 21 receives, from the calculation unit 19, the determination result indicating that the impedance is not within the specified range, the control unit 21 returns the processing to Step S12 and continues driving of the stirring unit 11 and the pump 13. Note that in the case where the control unit 21 receives, from the calculation unit 19, the determination result indicating that the impedance is less than the specified range or less than a specified value, the control unit 21 may return the processing to Step S12 and continue driving of the stirring unit 11 and the pump 13.

[2.3 Method of Controlling Temperature of Paint]

Hereinafter, an example of a method of controlling the temperature of paint in the above-mentioned stirring apparatus will be described with reference to FIG. 5.

First, in Step S21, the control unit 21 measures an initial temperature To of paint flowing through the pipe 12B by the temperature measuring unit 15. The measured initial temperature To is provided to the calculation unit 19. It is favorable to measure the initial temperature To at the time of the first impedance measurement from the viewpoint of improving the evaluation accuracy of dispersibility.

Next, in Step S22, the control unit 21 measures a temperature T of paint flowing through the pipe 12B after a specified period has elapsed from the measurement of the initial temperature To of paint or the previous measurement of the temperature T of paint. The measured temperature T is provided to the calculation unit 19.

Next, in Step S23, the calculation unit 19 determines, on the basis of the initial temperature To and the temperature T after the elapse of the specified period provided from the temperature measuring unit 15, whether or not there is a change in the temperature T after the elapse of the specified period using the initial temperature To as a reference, and provides the determination result to the control unit 21. Note that the method of determining the temperature change by the calculation unit 19 is not limited to this example, and the calculation unit 19 may determine, on the basis of the temperature T provided from the temperature measuring unit 15, whether or not there is a change in the temperature T measured this time using the previously-measured temperature T as a reference, and provide the determination result to the control unit 21.

In the case where the determination result indicating that there is a temperature change is provided from the calculation unit 19 and the valve 17A₁ is closed, the control unit 21 opens the valve 17A₁ in Step S24. As a result, circulation of the cooling water by the pipe 17A is started, and cooling of paint flowing through the pipe 12B is started. Further, in the case where the determination result indicating that there is a temperature change is provided from the calculation unit 19 and the valve 17A₁ is opened, the control unit 21 holds the valve 17A₁ in an opened state. As a result, the circulation of the cooling water by the pipe 17A is continued, and the cooling of paint flowing through the pipe 12B is continued.

Meanwhile, in the case where the determination result indicating that there is no temperature change is provided from the calculation unit 19 and the valve 17A₁ is opened, the control unit 21 closes the valve 17A₁ in Step S25. As a result, the circulation of the cooling water circulating through the pipe 17A is stopped, and the cooling of paint flowing through the pipe 12B is stopped. Further, in the case where the determination result indicating that there is no temperature change is provided from the calculation unit 19 and the valve 17A₁ is closed, the control unit 21 holds the valve 17A₁ in a closed state. As a result, the state in which the cooling water does not circulate through the pipe 17A is maintained, and the state in which paint flows through the pipe 12B without the cooling processing is maintained.

[2.4 Method of Controlling Concentration of Paint]

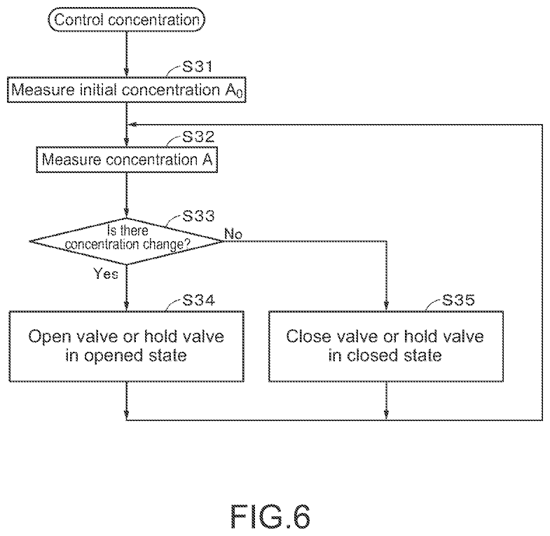

Hereinafter, an example of a method of controlling the concentration of paint in the above-mentioned stirring apparatus will be described with reference to FIG. 6.

First, in Step S31, the control unit 21 measures an initial concentration A₀ of paint flowing through the pipe 12B by the concentration measuring unit 16. The measured initial concentration A₀ is provided to the calculation unit 19. It is favorable to measure the initial concentration A₀ at the time of the first impedance measurement from the viewpoint of improving the evaluation accuracy of dispersibility.

Next, in Step S32, the control unit 21 measures a concentration A of paint flowing through the pipe 12B after a specified period has elapsed from the measurement of the initial concentration A₀ of paint or the previous measurement of the concentration A of paint. The measured concentration A is provided to the calculation unit 19.

Next, in Step S33, the calculation unit 19 determines, on the basis of the initial concentration A₀ and the concentration A after the elapse of the specified period provided from the concentration measuring unit 16, whether or not there is a change in the concentration A after the elapse of the specified period using the initial concentration A₀ as a reference, and provides the determination result to the control unit 21. Note that the method of determining the concentration change by the calculation unit 19 is not limited to this example, and the calculation unit 19 may determine, on the basis of the concentration A provided from the concentration measuring unit 16, whether or not there is a change in the concentration A measured this time using the previously-measured concentration A as a reference, and provide the determination result to the control unit 21.

In the case where the determination result indicating that there is a concentration change is provided from the calculation unit 19 and the valve 18B₁ is closed, the control unit 21 opens the valve 18B₁ in Step S34. As a result, supply of a solvent from the tank 18A to the stirring unit 11 via the pipe 18B is started, and the concentration A of paint is adjusted (reduced). Further, in the case where the determination result indicating that there is a concentration change is provided from the calculation unit 19 and the valve 18B₁ is opened, the control unit 21 holds the valve 18B₁ in an opened state. As a result, the supply of a solvent from the tank 18A to the stirring unit 11 via the pipe 18B is maintained, and the adjustment (reduction) of the concentration A of paint is continued.

Meanwhile, in the case where the determination result indicating that there is no concentration change is provided from the calculation unit 19 and the valve 18B₁ is opened, the control unit 21 closes the valve 18B₁ in Step S35. As a result, the supply of a solvent from the tank 18A to the stirring unit 11 via the pipe 18B is stopped, and the adjustment (reduction) of the concentration A of paint is stopped. Further, in the case where the determination result indicating that there is no concentration change is provided from the calculation unit 19 and the valve 18B₁ is closed, the control unit 21 holds the valve 18B₁ in a closed state. As a result, the state in which the supply of a solvent from the tank 18A to the stirring unit 11 via the pipe 18B is stopped is maintained, and the state in which the adjustment (reduction) of the concentration A of paint is stopped is maintained.

[2.5 Effects]

The stirring apparatus according to the first embodiment includes the stirring unit 11 that stirs paint containing a magnetic powder, the impedance measuring unit 14 that measures an impedance of the paint containing a magnetic powder, and the control unit 21 that controls the stirring unit 11 on the basis of the measured impedance. With this configuration, it is possible to evaluate the dispersibility of the magnetic powder on the basis of the paint state, and control the dispersibility of the magnetic powder contained in paint on the basis of the evaluation result. By forming a magnetic layer using the paint whose dispersibility is controlled in this way, it is possible to improve the perpendicular orientation of the magnetic powder contained in the magnetic layer.

It is possible to show, on the basis of the paint state, the orientational properties that have been only known after applying paint to a base and drying the paint.

By using the effect on the dispersion state due to the dispersion step of paint or the preservation period of paint as a control index in production, it is possible to reduce the defect caused by the dispersion which has been revealed downstream of the process after the coating and drying.

Variations in the perpendicular orientation can be reduced and the nominal property values determined by the lower limit value of the variation can be improved.

The realization of in-line measurement allows the measurer to safely manage the dispersion state of paint without touching paint containing deleterious components. In addition, it is possible to reduce the number of measurement man-hours, and reduce the waste of measurement containers, and the like.

[2.6 Modified Example]

(Modified Example 1)

The case where the impedance of paint flowing through the pipe 12B is measured has been described in the above-mentioned first embodiment, the impedance of paint housed in the stirring unit 11 may be measured. Further, in addition to the stirring unit 11, a housing unit for housing paint may be further provided, and the impedance of paint may be measured in the housing unit. In this case, it is favorable that paint is circulated and supplied from the stirring unit 11 to the housing unit and the states of the paint in the housing unit and the stirring unit 11 are the same.

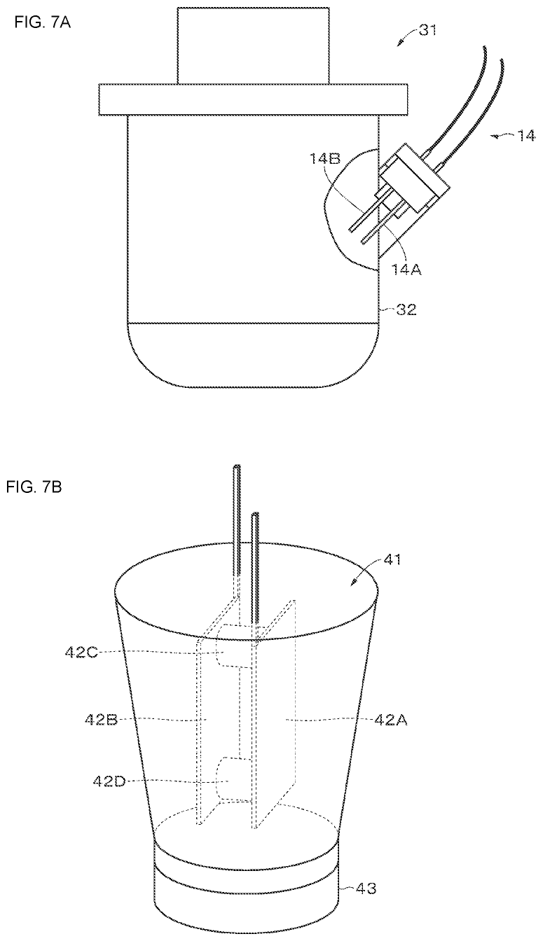

Part A of FIG. 7 shows an example of a configuration of a stirring unit 31 provided with the impedance measuring unit 14. The stirring unit 31 includes a housing unit 32 for housing paint, and the electrodes 14A and 14B of the impedance measuring unit 14 are provided in this housing unit 32. When paint is housed in the housing unit 32, the electrodes 14A and 14B are immersed in the paint.

In the stirring unit 31 having such a configuration, the housing unit 32 for housing paint is favorably formed of an insulating material. This is because by using an insulating material, it is possible to suppress generation of a stray current and improve the measurement accuracy of the impedance (i.e., the measurement accuracy of the dispersion state). Note that only a part of the housing unit 32 within a range where the leakage electric field from the electrodes 14A and 14B substantially reaches may be formed of an insulating material.

(Modified Example 2)

Although the case where the impedance of paint is measured by in-line measurement has been described in the above-mentioned first embodiment, the impedance of paint may be measured by off-line measurement. In this case, it does not necessarily need to provide the impedance measuring unit 14 in the first embodiment.

Part B of FIG. 7 is a schematic diagram for describing an example of off-line impedance measurement. In the case of the off-line impedance measurement, paint is taken out of the stirring unit 11 or the like to a container 41 and parallel-plate electrodes 42A and 42B are immersed in the paint housed in the container 41 to measure the impedance. Spacers 42C and 42D are provided between the electrodes 42A and 42B, and the distance between the electrodes 42A and 42B is kept constant.

It is favorable to maintain the measurement position of the electrodes 42A and 42B so that the height of the electrodes 42A and 42B from the bottom surface of the container 41 and the electrode position from the side surface of the container 41 do not vary for each time of the impedance measurement of paint. For measurement in a static state, the reproducibility of the positions of the container 41 for housing paint and the electrodes 42A and 42B and the positions of the liquid level of paint and the electrodes 42A and 42B are important to improve the accuracy of impedance measurement.

Further, the time period from taking out to measurement and the temperature control are also important for improving the measurement accuracy of the impedance. The measurement after being left to stand for a long time causes a change in the dispersion state and a change in concentration due to volatilization of solvent components and thus gives s factor of variation in the measurement value. Further, the temperature change causes a change in the resistivity and dielectric properties of paint and thus gives s factor of variation in the measurement value. Further, paint concentration control at the time of measurement is also important, and it is favorable to check whether or not there is any variation in concentration for each measurement sample. For example, it is favorable to perform concentration control on the basis of the ratio of the solution mass and the solid mass after volatilizing the solvent by heating. In the case where measurement is performed on the assumption that the variation in concentration is large, it is desirable to create a mapping of the dispersion, the concentration, and the impedance of paint by performing impedance measurement of paint prepared by controlling the dispersion and the concentration of paint, and evaluate the dispersion value converted to a certain specified concentration.

Further, the container 41 for housing paint favorably has an insulating property, and a pedestal portion 43 that receives a container favorably has an insulating property. It is favorable that lines of electric force of the alternating current applied between the electrodes 42A and 42B are closed within paint as much as possible. This is because the lines of electric force are disturbed when there is a conductive object in the peripheral portion, which gives a disturbance factor.

(Modified Example 3)

Although the case where the stirring apparatus controls the temperature and the concentration of paint to be constant has been described in the above-mentioned first embodiment, at least one of the temperature of the paint or the concentration of the paint may be controlled to be constant or the temperature and the concentration of paint do not necessarily need to be controlled to be constant. However, in an environment in which the concentration and the temperature of paint change, it is favorable to control the temperature and the concentration of paint to be constant from the viewpoint of improving the measurement accuracy of the impedance (i.e., the measurement accuracy of the dispersion state).

(Modified Example 4)

Although the method of producing paint containing a magnetic powder has been described in the above-mentioned first embodiment, the present disclosure is applicable also to a method of producing paint containing conductive particles other than the magnetic powder. For example, the present disclosure is applicable also to a method of producing a conductive ink or a conductive paste or a method of producing paint (electrode mixture slurry) of a battery.

The conductive ink or conductive paste includes, for example, conductive particles such as metal particles and carbon particles, a solvent, and, as necessary, a binder. The paint of the battery is for forming an active material layer, and includes an active material, a conductive auxiliary agent, and, as necessary, a binder. The active material may be one of a positive electrode active material and a negative electrode active material. Note that in the case where the present disclosure is applied to the method of producing paint of a battery, it is favorable to evaluate the dispersibility of the conductive auxiliary agent by measuring the impedance.

<3 Second Embodiment>

[3.1 Configuration of Magnetic Recording Medium]

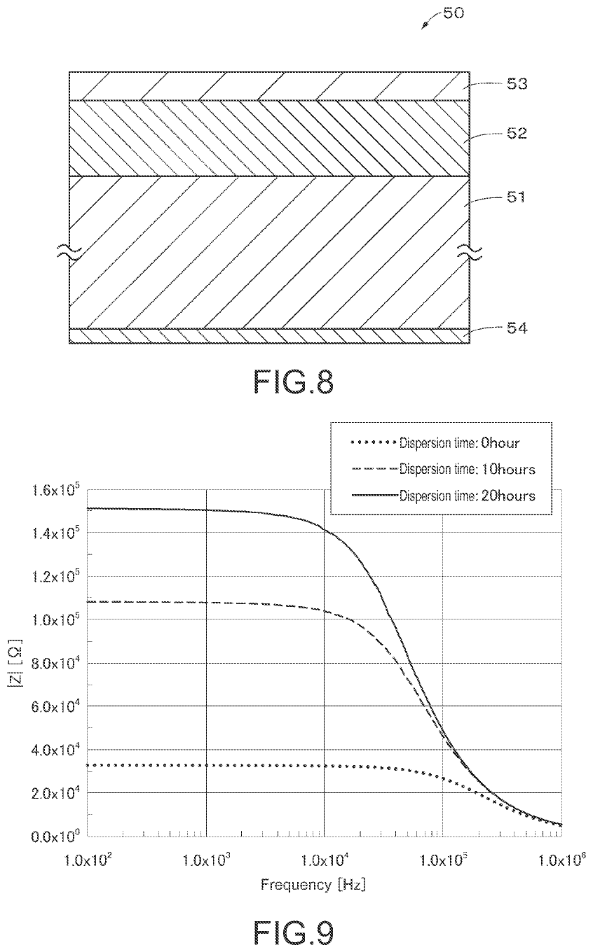

FIG. 8 shows an example of a configuration of a tape-shaped magnetic recording medium 50 according to a second embodiment. The magnetic recording medium 50 is a perpendicular magnetic recording type coating magnetic tape, and includes an elongated base 51, an underlayer (non-magnetic layer) 52 provided on one surface of the base 51, a magnetic layer (recording layer) 53 provided on the underlayer 52, and a back layer 54 provided on the other surface of the base 51. Note that the underlayer 52 and the back layer 54 are provided as necessary and do not necessarily need to be provided.

The magnetic layer 53 includes a magnetic powder and a binder. The magnetic layer 53 may further include, as necessary, at least one additive of a lubricant, an antistatic agent, an abrasive, a curing agent, a rust inhibitor, a non-magnetic reinforcing particle, and the like.

(Magnetic Powder)

The magnetic powder is oriented in the thickness direction of the magnetic recording medium 50 (perpendicular direction). As the magnetic powder, for example, a s-iron oxide magnetic powder, a spinel ferrite magnetic powder (e.g., Co-containing spinel ferrite magnetic powder), or a hexagonal ferrite magnetic powder (e.g., barium ferrite magnetic powder) is used.

The average particle size of the magnetic powder is favorably 30 nm or less, more favorably 8 nm or more and 25 nm or less, and still more favorably 12 nm or more and 22 nm or less. When the average particle size of the magnetic powder is 30 nm or less, favorable electromagnetic conversion characteristics can be achieved in the magnetic recording medium 50 having high recording density. Meanwhile, when the average particle size of the magnetic powder is 8 nm or more, the dispersibility of the magnetic powder is improved and more excellent electromagnetic conversion characteristics can be achieved.

The above-mentioned average particle size of the magnetic powder is obtained as follows. First, a magnetic powder is imaged by TEM. Next, 50 magnetic particles are randomly selected from the obtained TEM photograph, and the major-axis length of each of the magnetic particles is measured. Here, the major-axis length means the largest one (so-called maximum Feret diameter) of distances between two parallel lines drawn from all angles so as to be in contact with the contour of the magnetic particle. Subsequently, the measured major-axis lengths of the 50 magnetic particles are simply averaged (arithmetically averaged) to obtain the average major-axis length. The average major-axis length obtained in this way is used as the average particle size of the magnetic powder.

(Binder)

Examples of the binder include thermoplastic resin, a thermosetting resin, and a reactive resin. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyurethane resin, a polyester resin, an amino resin, and synthetic rubber.

Examples of the thermosetting resin include a phenol resin, an epoxy resin, a polyurethane curable rein, a urea resin, a melamine resin, an alkyd resin, a silicone resin, a polyamine resin, and an urea formaldehyde resin.

For the purpose of improving dispersibility of the magnetic powder, a polar functional group such as —SO₃M, —OSO₃M, —COOM, P═O(OM)₂ (where M represents a hydrogen atom or an alkali metal such as lithium, potassium, and sodium), a side chain amine having a terminal group represented by —NR1R2 or —NR1R2R3⁺X⁻, a main chain amine represented by >NR1R2⁺X⁻(where R1, R2, and R3 each represent a hydrogen atom or a hydrocarbon group, and X⁻ represents a halogen element ion such as fluorine, chlorine, bromine, and iodine, an inorganic ion, or an organic ion), —OH, —H, —CN, and an epoxy group may be introduced into all of the above-mentioned binders. The amount of these polar functional groups to be introduced into the binder is favorably 10⁻¹ to 10⁻⁸ mol/g, and more favorably 10⁻² to 10⁻⁶ mol/g.

[3.2 Method of Producing Magnetic Recording Medium]

Next, an example of a method of producing the magnetic recording medium 50 having the above-mentioned configuration will be described.

First, paint for forming a magnetic layer is produced in the same way as that of the method of producing paint according to the first embodiment. Examples of the solvent used for the paint for forming a magnetic layer include a ketone solvent such as acetone, methyl ethyl ketone, methyl isobutyl ketone, and cyclohexanone, an alcohol solvent such as methanol, ethanol, and propanol, an ester solvent such as methyl acetate, ethyl acetate, butyl acetate, propyl acetate, ethyl lactate, and ethylene glycol acetate, an ether solvent such as diethylene glycol dimethyl ether, 2-ethoxyethanol, tetrahydrofuran, and dioxane, an aromatic hydrocarbon solvent such as benzene, toluene, and xylene, and a halogenated hydrocarbon solvent such as methylene chloride, ethylene chloride, carbon tetrachloride, chloroform, and chlorobenzene. These may be used alone or may be appropriately mixed and used.

Next, paint for forming an underlayer is applied to one main surface of the base 51 and dried to form the underlayer 52. Subsequently, the magnetic layer 53 is formed on an underlayer 12 by applying the paint for forming a magnetic layer on this underlayer 52 and drying the paint. Note that during drying, for example, the magnetic field of the magnetic powder is oriented in the thickness direction of the base 51 by a solenoid coil. Further, during drying, for example, after the magnetic field of the magnetic powder is oriented in the traveling direction of the base 51 (longitudinal direction), the magnetic field of the magnetic powder may be oriented in the thickness direction of the base 51 by a solenoid coil. After the magnetic layer 53 is formed, the back layer 54 is formed on the other main surface of the base 51. As a result, the magnetic recording medium 50 is obtained.

After that, the obtained magnetic recording medium 50 is wound around the large-diameter core, and curing processing is performed thereon. Finally, calendaring processing is performed on the magnetic recording medium 50, and the magnetic recording medium 50 is cut to a predetermined width (e.g., ½ inch width). In this way, a target elongated magnetic recording medium 50 can be obtained.

[3.3 Measurement Value of Paint]

Hereinafter, the results of measuring paint when a barium ferrite magnetic powder is used as the magnetic powder will be described.

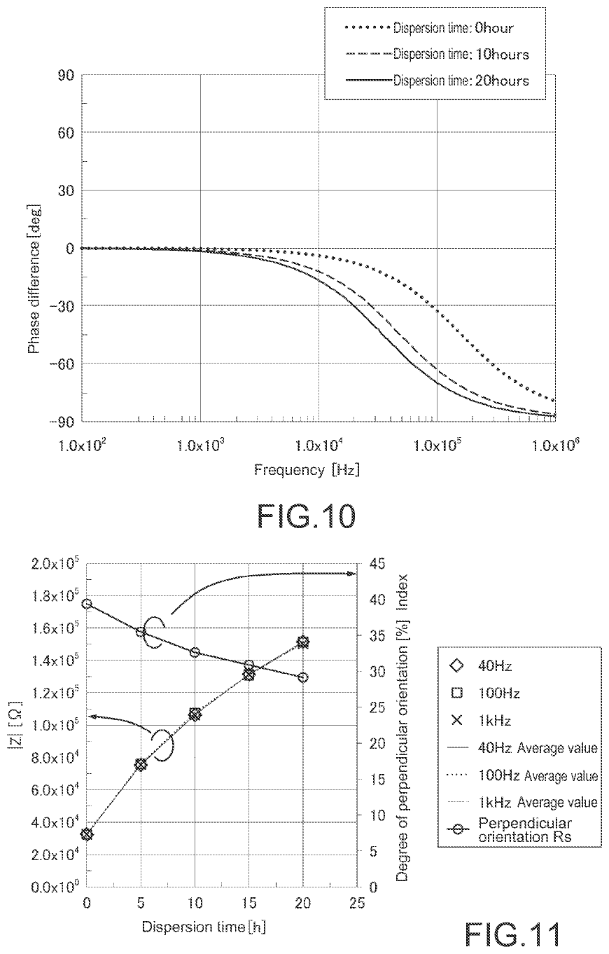

FIG. 9 shows a relationship between the frequency and the impedance in the case where the dispersion time of paint is changed. FIG. 10 shows a relationship between the frequency and the phase difference (phase difference of a voltage with respect to a current at the time of impedance measurement) in the case where the dispersion time of paint is changed. FIG. 11 shows a relationship between the dispersion time, the impedance, and the degree of perpendicular orientation with 100 Hz as a typical value, out of the frequency range from 100 Hz to 1000 Hz in which the impedance is almost constant. Note that the degree of perpendicular orientation is a squareness ratio measured in the longitudinal direction of the magnetic recording medium 50, the decrease in the degree of horizontal orientation represents the improvement in the degree of perpendicular orientation. From this result, it can be seen that the paint impedance value increases and the perpendicular orientation is improved as the dispersion time of paint is longer.

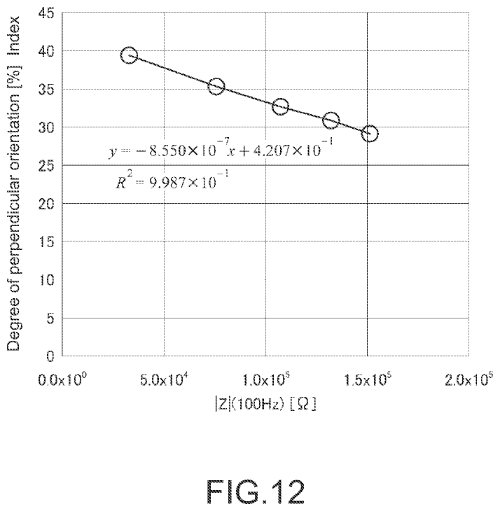

For easier comprehension, a graph showing the correlation between the impedance and the degree of perpendicular orientation is shown in FIG. 12. It can be seen from FIG. 12 that the impedance and the degree of perpendicular orientation are highly correlated.

[3.4 Effects]

The method of producing the magnetic recording medium 50 according to the second embodiment includes measuring an impedance of paint containing a magnetic powder, controlling, on the basis of the measured impedance, dispersibility of the magnetic powder contained in the paint, and forming a magnetic layer using the paint whose dispersibility is controlled. As a result, the perpendicular orientation of the magnetic powder contained in the magnetic layer can be improved. Therefore, it is possible to reduce the magnetization transition width and obtain a high-output signal at the time of signal reproduction, and thus, it is possible to improve the electromagnetic conversion characteristics.

[3.5 Modified Example]

Although the case where the present disclosure is applied to the perpendicular magnetic recording type coating magnetic tape has been described in the above-mentioned second embodiment, the present disclosure is applicable also to a horizontal magnetic recording type coating magnetic tape. In this case, as the magnetic powder, for example, a metal magnetic powder is used.

Although embodiments of the present disclosure have been specifically described above, the present disclosure is not limited to the above-mentioned embodiments, and various modifications based on the technological idea of the present disclosure can be made.

For example, the configurations, the methods, the processes, the shapes, the materials, and the numerical values cited in the above-mentioned embodiments are only illustrative, and different configurations, methods, processes, shapes, materials, and numerical values may be used as necessary.

Further, the configurations, the methods, the processes, the shapes, the materials, and the numerical values in the above-mentioned embodiments can be combined without departing from the essence of the present disclosure.

In the numerical value range described stepwise in the above-mentioned embodiments, the upper limit value or the lower limit value of the numerical value range of one stage may be replaced by the upper limit value or the lower limit value of the numerical value range of another stage. The materials exemplified in the above-mentioned embodiments may be used alone or two or more of them may be used in combination unless otherwise specified.

Further, the present disclosure may also take the following configurations.

(1) A method of producing paint, including:
measuring an impedance of paint containing a magnetic powder; and
controlling stirring of the paint on a basis of the measured impedance.
   (2) The method of producing paint according to (1), in which
the measuring an impedance is performed by applying an AC voltage to the paint.
   (3) The method of producing paint according to (2), in which
a frequency of the AC voltage is 10 Hz or more and 1000 Hz or less.
   (4) The method of producing paint according to any one of (1) to (3), in which
the controlling stirring of the paint is performed such that the impedance is within a specified range.
   (5) The method of producing paint according to any one of (1) to (4), in which
the controlling stirring of the paint is controlling at least one of a stirring period of the paint or a stirring speed of the paint.
   (6) The method of producing paint according to any one of (1) to (5), in which
the measuring an impedance is performed using the paint flowing through a pipe.
   (7) The method of producing paint according to (6), further including
controlling a flow rate of the paint flowing through the pipe to be constant.
   (8) The method of producing paint according to any one of (1) to (5), in which
the measuring an impedance is performed using the paint housed in a stirring unit.
   (9) The method of producing paint according to (8), further including
controlling at least one of a temperature of the paint or a concentration of the paint to be constant.
   (10) A stirring apparatus, including:
a stirring unit that stirs paint containing a magnetic powder;
an impedance measuring unit that measures an impedance of the paint; and
a control unit that controls the stirring unit on a basis of the measured impedance.
   (11) The method of producing paint according to (10), in which
the impedance measuring unit measures the impedance by applying an AC voltage to the paint.
   (12) The stirring apparatus according to (10) or (11), further including
a pipe through which the paint stirred by the stirring unit flows, in which
the impedance measuring unit measures an impedance of the paint flowing through the pipe.
   (13) The stirring apparatus according to (12), further including
a pump that supplies the paint from the stirring unit to the pipe, in which
the control unit controls the pump such that a flow rate of the paint flowing through the pipe to be constant.
   (14) The stirring apparatus according to (10) or (11), in which
the impedance measuring unit measures an impedance of the paint housed in the stirring unit.
   (15) The stirring apparatus according to any one of (10) to (14), in which
the impedance measuring unit includes a pair of electrodes facing each other, the stirring apparatus further including
a Zener diode explosion-proof barrier provided between a main body of the impedance measuring unit and the pair of electrodes.
   (16) The stirring apparatus according to any one of (10) to (14), in which
the impedance measuring unit includes a pair of electrodes facing each other, and
a periphery of the pair of electrodes is formed of an insulating material.
   (17) The stirring apparatus according to any one of (10) to (16), further including:
a temperature measuring unit that measures a temperature of the paint; and
a cooling unit that cools the paint, in which
the control unit controls, on a basis of a measurement result of the temperature measuring unit, the cooling unit such that the temperature of the paint is constant.
   (18) The stirring apparatus according to any one of (10) to (17), further including:
a concentration measuring unit that measures a concentration of the paint; and
a solvent supplying unit that supplies a solvent to the paint, in which
the control unit controls, on a basis of a measurement result of the concentration measuring unit, the cooling unit such that the concentration of the paint is constant.
   (19) A method of producing a magnetic recording medium, including:
measuring an impedance of paint containing a magnetic powder;
controlling stirring of the paint on a basis of the measured impedance; and
forming a magnetic layer using the paint, stirring of the paint being controlled.
   (20) A method of measuring dispersibility of paint, including: measuring an impedance of paint containing a magnetic powder.

### REFERENCE SIGNS LIST

11 stirring unit
12A, 12B pipe
12A1 valve
13 pump
14 impedance measuring unit
14A, 14B electrode
15 temperature measuring unit
16 concentration measuring unit
17 cooling unit
17A pipe
17A1 valve
18 solvent supplying unit
18A tank
18B pipe
18B1 valve
19 calculation unit
20 setting unit
21 control unit
31 stirring unit
32 housing unit
41 container
42A, 42B electrode
42C, 42D spacer
43 pedestal portion
50 magnetic recording medium
51 base
52 underlayer
53 magnetic layer
54 back layer

1. A method of producing paint, comprising:
measuring an impedance of paint containing a magnetic powder; and
controlling stirring of the paint on a basis of the measured impedance.

2. The method of producing paint according to claim 1, wherein
the measuring an impedance is performed by applying an AC voltage to the paint.

3. The method of producing paint according to claim 2, wherein
a frequency of the AC voltage is 10 Hz or more and 1000 Hz or less.

4. The method of producing paint according to claim 1, wherein
the controlling stirring of the paint is performed such that the impedance is within a specified range.

5. The method of producing paint according to claim 1, wherein
the controlling stirring of the paint is controlling at least one of a stirring period of the paint or a stirring speed of the paint.

6. The method of producing paint according to claim 1, wherein
the measuring an impedance is performed using the paint flowing through a pipe.

7. The method of producing paint according to claim 6, further comprising
controlling a flow rate of the paint flowing through the pipe to be constant.

8. The method of producing paint according to claim 1, wherein
the measuring an impedance is performed using the paint housed in a stirring unit.

9. The method of producing paint according to claim 1, further comprising
controlling at least one of a temperature of the paint or a concentration of the paint to be constant.

10. A stirring apparatus, comprising:
a stirring unit that stirs paint containing a magnetic powder;
an impedance measuring unit that measures an impedance of the paint; and
a control unit that controls the stirring unit on a basis of the measured impedance.

11. The method of producing paint according to claim 10, wherein
the impedance measuring unit measures the impedance by applying an AC voltage to the paint.

12. The stirring apparatus according to claim 10, further comprising
a pipe through which the paint stirred by the stirring unit flows, wherein
the impedance measuring unit measures an impedance of the paint flowing through the pipe. cm 13. The stirring apparatus according to claim 12, further comprising
a pump that supplies the paint from the stirring unit to the pipe, wherein
the control unit controls the pump such that a flow rate of the paint flowing through the pipe to be constant.

14. The stirring apparatus according to claim 10, wherein
the impedance measuring unit measures an impedance of the paint housed in the stirring unit.

15. The stirring apparatus according to claim 10, wherein
the impedance measuring unit includes a pair of electrodes facing each other, the stirring apparatus further comprising
a Zener diode explosion-proof barrier provided between a main body of the impedance measuring unit and the pair of electrodes.

16. The stirring apparatus according to claim 10, wherein
the impedance measuring unit includes a pair of electrodes facing each other, and
a periphery of the pair of electrodes is formed of an insulating material.

17. The stirring apparatus according to claim 10, further comprising:
a temperature measuring unit that measures a temperature of the paint; and
a cooling unit that cools the paint, wherein
the control unit controls, on a basis of a measurement result of the temperature measuring unit, the cooling unit such that the temperature of the paint is constant.

18. The stirring apparatus according to claim 10, further comprising:
a concentration measuring unit that measures a concentration of the paint; and
a solvent supplying unit that supplies a solvent to the paint, wherein
the control unit controls, on a basis of a measurement result of the concentration measuring unit, the cooling unit such that the concentration of the paint is constant.

19. A method of producing a magnetic recording medium, comprising:
measuring an impedance of paint containing a magnetic powder;
controlling stirring of the paint on a basis of the measured impedance; and
forming a magnetic layer using the paint, stirring of the paint being controlled.

20. A method of measuring dispersibility of paint, comprising:
measuring an impedance of paint containing a magnetic powder.
